(19) United States
(12) Patent Application Publication
(10) Pub. No.: US 2007/0175074 A1
(43) Pub. Date: Aug. 2, 2007

(54) Fuel effect fires

(75) Inventor: Noel O'Neill, Drogheda (IE)

Correspondence Address: TROUTMAN SANDERS LLP, 600 PEACHTREE STREET , NE, ATLANTA, GA, 30308, US

(73) Assignee: Basic Hokdings, Dublin (IE)

(21) Appl. No.: 10/589,518

(22) PCT Filed: Feb. 18, 2005
(86) PCT No.: PCT/EP05/01668

§ 371 Date: Sep. 18, 2006

(30) Foreign Application Priority Data
Feb. 18, 2004 (GB) 0403601.8

(51) Int. Cl. G09F 19/00

(52) U.S. Cl. 40/428

(57) ABSTRACT

A simulated fuel element for a fuel effect fire comprises a body of foam material shaped and coloured to resemble a piece of real fuel, such as a log. The foam material may be a polyurethane foam. The fuel element is substantially non-translucent of light and may be provided with a hollow interior for the transmission of light from a light source of a fuel effect fire, giving a glowing appearance to the fuel element. The fuel element may also include crevices with which may also transmit light from the light source. Transmitted light may be reflected from dark reflective surfaces to enhance the burning appearance of the fuel element. Colour filters or the like may be used to provide coloured light incident on the fuel elements.

The present invention relates to fires, in particular electric fires, and to simulated fuel pieces or components used in such fires.

Simulated fuel effect fires are well known in the art and comprise a simulated fuel bed which simulates burning logs, coal or the like. Simulated fuel beds may comprise a single relatively thin rigid plastic moulding such as of a hard polythene, polyvinylchloride, Perspex™ or similar hard or dense plastic, shaped and coloured to represent burning fuel and embers. Other known fuel beds include individual opaque pieces of simulated fuel resting on a moulded plastic base typically constructed to resemble an ember bed. The individual fuel pieces are shaped and coloured to represent coals, logs or the like and are made from hard plastic mouldings. In some cases, real pieces of fuel such as coal or logs have been used. The moulded fuel bed and/or ember bed may have areas which are at least partially translucent, e.g. by having a local absence of the paint or pigment which is used to give the simulated log or coal a realistic colour. The fuel bed or ember bed is typically illuminated from below and the translucent areas allow light to be transmitted through the fuel/ember bed. This is intended to provide an effect similar to glowing or flaring of the fuel bed such as occurs in a real fire.

Although the simulation of burning fuel in the known fires has reached a good standard, there is room for improvement. In particular conventional simulated fuel pieces are not ideal in achieving the effect that the pieces themselves are burning. The present invention seeks to provide improved simulated fuel components for an electric fire to provide an enhanced effect of burning logs, coals or the like.

According to a first aspect of the invention there is provided a simulated fuel element for a fuel effect fire comprising:

a body of material having at least a first part of its external surface, which is visible when the simulated fuel element is in its intended position of use, shaped and coloured to resemble a real fuel element;
wherein the body of material comprises a rigid substantially non-transparent foam material.

Preferably, the body of material comprises a polyurethane foam.

Preferably the fuel element comprises at least one region having a dark-coloured and light-reflecting surface. To provide an authentic appearance desirably the dark coloured surface is at least primarily black and/or mid to dark brown. For convenience of manufacture the light reflecting surface may comprise a coating material selected from a lacquer, varnish or gloss paint applied to the surface of the simulated fuel element.

Most preferably said dark coloured surface is a non-planar surface and in particular a rough or irregular surface. This enhances the simulation of burning fuel by reflecting incident light in a pseudo-random manner, which contributes to the effect of glowing or sparking embers on the fuel piece.

In a particularly preferred embodiment the fuel element comprises a crevice, cleft, fissure or the like extending towards the interior of the fuel element from an external surface thereof, as may often be found in a natural burning log or coal or the like.

In an advantageous variation of this embodiment the region having a dark coloured surface is provided on an internal surface of said crevice, cleft or fissure. Light may then be reflected from the surface, giving the appearance of glowing embers or the like within the crevice.

In another preferred embodiment the fuel element further comprises at least one cut-out, passage or channel extending into said crevice, cleft or fissure from a surface thereof not visible when the fuel element is in its intended position of use. Preferably the at least one cut-out or channel terminates at a point in said crevice, cleft or fissure which is not visible when the fuel element is in its intended position of use.

In another preferred embodiment the simulated fuel element comprises at least one internal cavity having an open face on a side of said element not visible when the fuel element is in its intended position of use and defining a wall region between said cavity and an area of the surface of the element which is visible is use, said wall region having a thickness sufficiently small that it is partially translucent to light incident on the wall region.

In another preferred variation the simulated fuel element further comprises pieces of reflective material applied to an external surface thereof. The reflective pieces may be positioned to reflect light onto said at least one region having a dark-coloured and light-reflecting surface.

According to a second aspect of the invention there is provided a simulated fuel effect fire including a fuel bed and a light source located below the fuel bed, the fuel bed comprising:
i. an ember bed; and
ii. at least one fuel element mounted on the ember bed and comprising a body of material having at least a first part of its external surface, which part is visible when the simulated fuel element is so mounted, shaped and coloured to resemble a real fuel element, wherein the body of material comprises a rigid substantially non-transparent foam material.

Preferably the body of material comprises a polyurethane foam.

Preferably the fuel element comprises at least one region having a dark-coloured and light-reflecting surface on which light from the light source is directly or indirectly incident. For enhanced realism, the dark coloured surface is most preferably black and/or mid to dark brown. The light reflecting surface may usefully comprise a coating material selected from a lacquer, varnish or gloss paint applied to the surface of the simulated fuel element.

Preferably said dark coloured surface is a non-planar surface and more particularly a rough or irregular surface. Thus, light from the light source, which is reflected from this surface, enhances the illusion of the burning of the fuel piece by simulating the glowing of embers, sparks or the like on the fuel element.

In a much preferred embodiment of the simulated fuel effect fire said fuel element comprises a crevice, cleft, fissure or the like extending towards the interior of the fuel element from an external surface thereof.

Preferably in this embodiment the fuel element further comprises at least one cut-out, passage or channel extending from a surface thereof not visible when the fuel element is mounted on the ember bed into said crevice, cleft or fissure through which cut-out, passage or channel light from the light source may pass into the crevice, cleft or fissure. In this way, light from the light source may pass from below the fuel bed directly into the crevice, cleft or fissure and be reflected by the dark coloured surface, providing the illusion of glowing embers, sparks or the like within the crevice, cleft or fissure. Also, light passing through cut-out, passage or channel into the crevice, cleft or fissure may be incident on a said dark coloured surface of a further fuel element mounted above said crevice, cleft or fissure. Preferably said at least one cut-out, passage or channel terminates at a point in said crevice, cleft or fissure which is not visible when the fuel element is in its intended position of use. In this way, the cut-out itself, and any components disposed below the aperture in the ember bed adjacent the cut-out are not visible to a user of the fire.

In another preferred embodiment of the simulated fuel effect fire the ember bed comprises at least one hole or substantially transparent area for the passage of light from the light source. Preferably, a coloured filter is provided in the path of light through said hole or substantially transparent area. In this way, light incident on the fuel elements may be coloured. Typical filters may be red or orange but other colours which may be perceived in real flames, such as yellow, green and blue, may be used.

In a further preferred embodiment of the simulated fuel effect fire said fuel element comprises at least one internal cavity having an open face on a side of said element not visible when the fuel element is mounted on the ember bed and defining a wall region between said cavity and an area of the surface of the element which is visible is use, said wall region having a thickness sufficiently small that it is partially translucent to light from the light source directly or indirectly incident on the wall region. Most preferably, said open face is disposed over a hole or substantially transparent area of the ember bed.

Preferably in this aspect of the invention the fuel element further comprises pieces of reflective material applied to an external surface thereof. These pieces of reflective material are desirably so positioned that light from the light source is incident thereon and further preferably so that light is reflected by said reflective pieces onto a region having a dark coloured and light-reflecting surface.

In a particularly preferred embodiment the simulated fuel effect fire further comprises a reflective screen mounted behind the fuel bed whereby a reflection of the fuel bed may be observed in the reflective screen.

Preferably at least one dark-coloured and light-reflecting surface of a fuel element is arranged to face the reflective screen whereby a reflection of the said surface may be observed in the reflective screen.

For a better understanding of the invention and to show how the same may be carried into effect, reference will be made, by way of example only, to the following drawings in which:

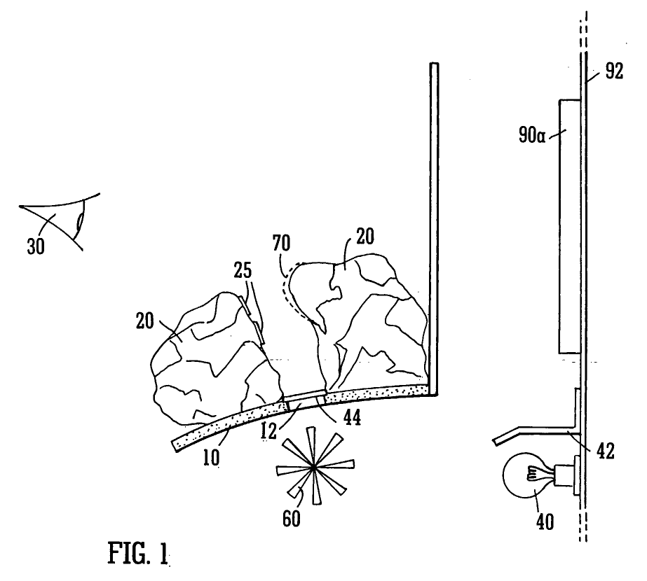

FIG. 1 is a schematic cross sectional view of a parts of a simulated fuel effect fire according to a first variation of the invention;

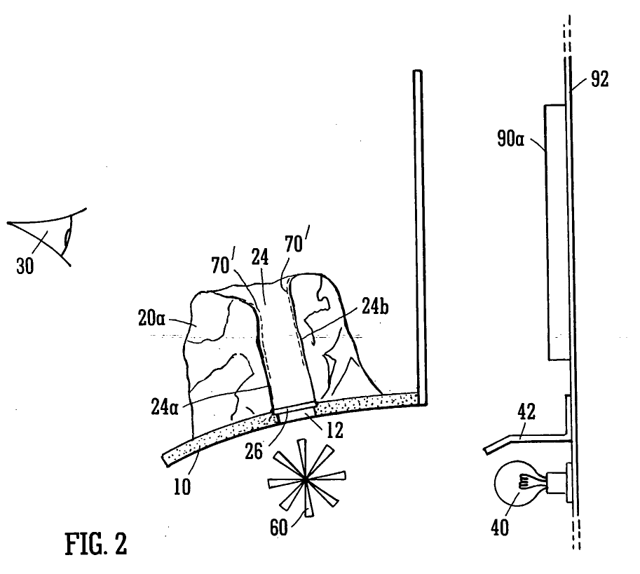

FIG. 2 is a schematic cross sectional view of parts of a simulated fuel effect fire according to a second variation of the invention;

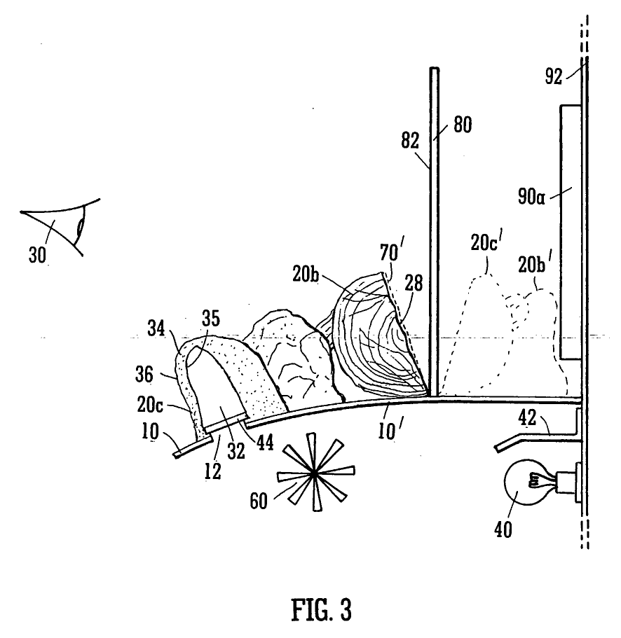

FIG. 3 is a schematic cross sectional view of parts of a simulated fuel effect fire according to a third variation of the invention;

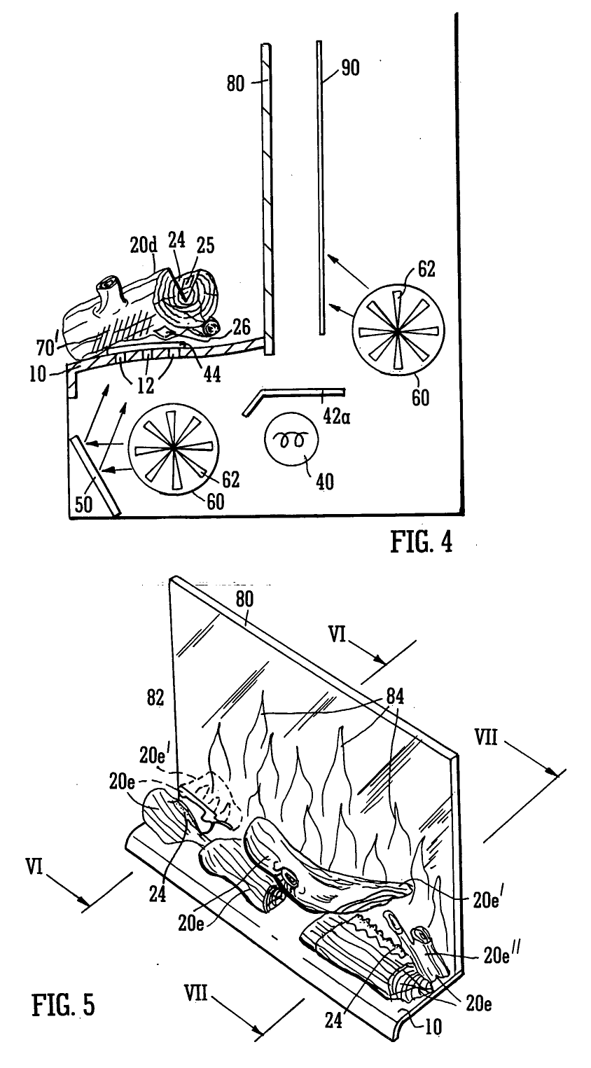

FIG. 4 is a schematic cross sectional view of a of a simulated fuel effect fire according to the invention;

FIG. 5 is a perspective view of a typical fuel bed including fuel elements, according to the invention;

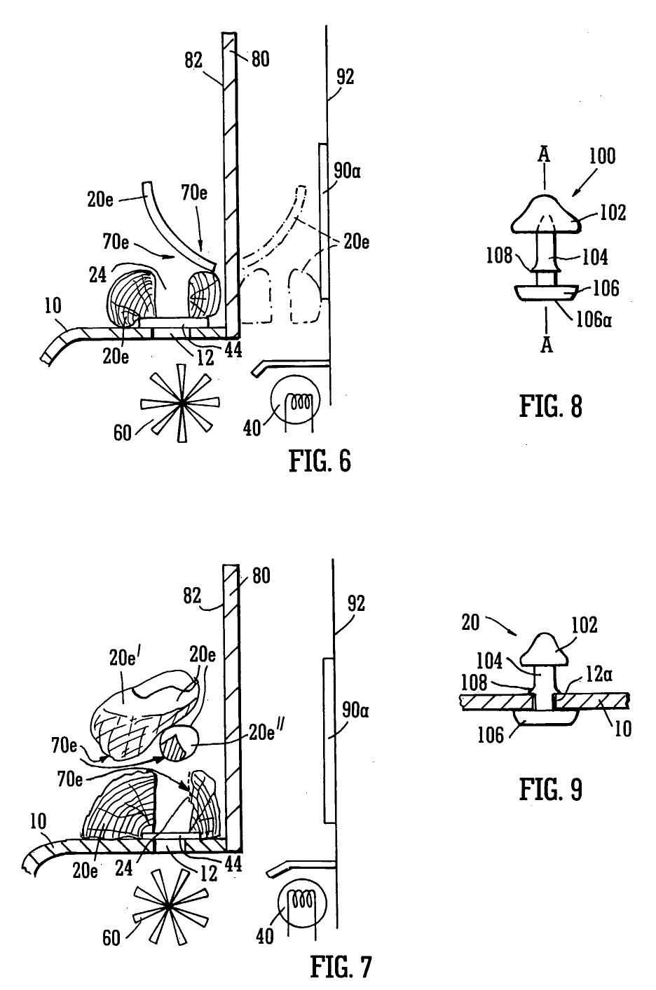

FIG. 6 is a cross-section along line 6-6 of FIG. 5;

FIG. 7 is a cross-section along line 7-7 of FIG. 5;

FIG. 8 shows a fixing for securing a fuel element according to the invention to an ember bed; and

FIG. 9 shows the fixing of FIG. 5 in use.

Referring now in particular to FIG. 1, the fuel bed comprises an ember bed 10 which supports one of more simulated fuel elements 20. The ember bed may conveniently be made from a moulding of a rigid, hard transparent (or at least translucent) plastic material which is coloured, such as by painting, to resemble a glowing bed of embers as in a real solid fuel fire. For example, the ember bed 10 may be coloured in primarily shades of brown, grey, red and orange. The fuel elements 20 rest on the fuel bed so that at least parts of them are visible to an observer indicated at 30.

The fuel elements 20 comprise a rigid (that is, substantially non-resilient, largely incompressible) foam material. A typical foam material is a polyurethane foam. The fuel elements 20 can be formed from such materials in a variety of highly realistic shapes—i.e. to resemble coals, logs, peat or the like—by, for example moulding the fuel elements 20 in rubber moulds. After forming, the fuel elements 20 are coloured to resemble burning pieces of real solid fuel. The fuel elements 20 may be painted on their surface in appropriate colours such as browns, blacks, greys greens, oranges and reds as appropriate.

The ember bed 10 is illuminated from below by a light source 40. The light source 40 may illuminate the underside of the ember bed 10 directly and/or indirectly. In the latter case, as shown in FIG. 1, the light source 40 may be disposed in a position such that light from the light source 40 falls on the underside of the ember bed 10 after reflection by a reflector 50 (FIG. 4) and/or a flicker element 60 (60′). In the particular arrangement of FIG. 4 the light from the light source 40 is reflected by both the reflector 50 and the flicker element 60′. Flicker elements are well known in the art and are otherwise known as devices for giving the appearance of movement to light incident on, for example, an ember bed. One known flicker element comprises a number of strips of reflective material 62 extending outwardly (e.g. radially) from a shaft. The shaft is rotated about its axis and the light from the light source is reflected by the strips of reflective material onto parts of the ember bed 10′. A baffle 42 is preferably provided which may prevent light from the light source from falling directly on the fuel bed 10, or may reduce the amount of light from the light source which directly incident on the fuel bed.

At least one fuel element 20 on a fuel bed 10 according to the invention is provided with a region on its outer surface which is both glossy and reflective and is primarily dark coloured (to resemble the surface of a piece of real fuel). The reflective surface is indicated schematically in the drawings by dotted lines 70, 70′, 70″. Conveniently, the reflective surface may be provided by coating the surface 70, 70′, 70″ with a glossy paint, lacquer, varnish or the like. In combination with incident light from the light source 40, the reflective surface enhances the appearance of burning fuel by providing local areas of more intense light as observed by the observer 30. This effect is enhanced further by colouring the light in a suitable “burning” colour which will typically be primarily red or orange but may also be blue or green. The colouring of the light from the light source 40 can be achieved, for example, by using a coloured light bulb or by passing the light through one or more coloured filters before it is incident on the fuel pieces 30. A coloured filter 44 is shown in FIG. 1 and may typically be a piece of red or orange coloured transparent plastic. Coloured reflectors can alternatively (or additionally) be used. Furthermore, the surfaces 70, 70′ and 70″ are preferably non-planar surfaces, in particular rough or irregular surfaces. In this way, the areas of more intense light become more localised and better resemble glowing localised areas of a real piece of burning fuel. A still greater enhancement is achieved by using a flicker element 60 or the like so that the intensity of the light falling on a given area of a surface 70, 70′, 70″ is not constant. The localised areas of more intense light then themselves have a pseudo-randomly changing intensity which mimics more closely still a naturally burning piece of solid fuel where different areas of the fuel piece will burn—and hence glow—with different intensities at any given time.

Referring more specifically to FIG. 1, the fuel bed includes front and rear (as observed by the observer 30) fuel elements 20 resting on the ember bed 10. The reflective area 70 is formed on the front surface of the real fuel piece 70 and at least part of the area 70 is visible to the user when the user is in a normal use position. Typically, the user will be standing or sitting in front of a fuel effect fire of which the illustrated fuel bed forms a part. Light from the light source 40 is incident on the rear fuel piece 20 in part by transmission through the ember bed 10 but also directly through one or more apertures 12 in the ember bed 10. The or each aperture 12 is located so that it is hidden in use form the observer 30 by the front fuel element 20. The fuel elements 20 may also be provided with localised reflective areas 25, such as relatively small pieces of a metallic or metallised material, or small areas of applied glitter, attached to the fuel element 20, which reflect light from the light source 40 onto the reflective surface 70, again providing localised areas of more intense light reflected to the observer 30 by the reflective surface 70. The areas 25 may be coloured. For example, the reflective areas 25 may be primarily red or orange but areas 25 which are blue or green may be provided, to mimic the colours actually produced by burning solid fuel. Thus the rear fuel element 70 is provided in the region 70 with localised areas of reflected light, preferably of varying intensity, so resembling the localised areas of light emission of a burning piece of solid fuel.

FIG. 2 shows in another variation of the invention a different arrangement of fuel elements 20a on an ember bed 10. The construction of the illustrated fuel element 20a is essentially the same as that of the fuel elements 20 of FIG. 1, that is, comprising a rigid (that is, substantially non-resilient, largely incompressible) foam material, typically a polyurethane foam. The fuel element 20a includes a crevice, cleft or fissure 24 mainly defined by walls 24a, 24b. At least the wall 24b, and possibly also the wall 24a, is provided with a reflective glossy area 70′ similar to area 70 of the fuel element 20 of FIG. 1. The wall 24b is at least partly visible by an observer 30 and the reflective surface 70′ will reflect at least ambient light. However, the fuel element 20a is further provided with at least one channel or passage 26 extending from a point on its underside proximate an aperture 12 of the ember bed 10. The fuel element 20a is constructed so that the lower part of the channel 26 is not normally visible to a user 30. More particularly, the user will not normally see the aperture 12. The aperture 12 may be provided with a coloured filter (not shown in FIG. 2) similar to filter 44 in FIG. 1. The filter may be any suitable colour for simulating burning fuel, typically red or orange but possibly green or blue. Light from the light source 40 passes through the channel or channels 26 and is reflected from the reflecting surface 70′ of wall 24b to provide the effect or illusion of the localised glow emitted by such a crevice in a genuine burning fuel element 20a. This construction adds perceived depth to the illusion of the burning fuel element 20a.

The fuel element 20a of this variation of the invention may also be provided with a glossy reflective surface 70′ on wall 24a. Light from the light source 40 which passes through channel 26 may be reflected from the surface 70′ of the wall 24a onto the surface 70′ of the wall 24b and further may be reflected by the latter surface to be perceived by the observer 30 as an enhanced burning illusion or effect. Further, localised reflective areas 25 may be applied to either of the walls 24a and 24b. These localised reflective areas reflect incident light passing through the channel 26 from the light source 40 in a similar manner to the corresponding localised areas 25 of FIG. 1.

Referring now in particular to FIG. 3 which illustrates a further variation of a fuel bed according to the invention comprising fuel elements 20c. The fuel elements 20c have the same basic construction as fuel elements 20 and 20a, that is, comprising a rigid (that is, substantially non-resilient, largely incompressible) foam material, typically a polyurethane foam. The fuel elements 20c have at least one internal cavity or void 32 which is arranged so that it is not visible to an observer 30 when the fuel element 20c is mounted on the ember bed 10. The cavity 32 most preferably opens above an aperture 12 in the fuel bed 10. The aperture 12 is preferably provided with a filter 44 which may preferably be a red or orange filter, but could alternatively be yellow green or blue or any other colour which may be observed in a burning piece of real fuel. Alternative means of providing coloured incident light, such as coloured bulbs 40 or coloured reflectors are also possible alternatives. In this way, light from light source 40 is incident on the interior of the cavity. Because the foam material from which the fuel element 20c is constructed is partially transmissive of light (i.e. partially translucent), some light incident on the cavity 32 passes through wall 34 of the fuel element 20c and can be perceived by an observer 30. The foam material of the fuel element 20c is diffusive of light passing through it and so the user perceives the light as a general glow from the fuel element. The intensity of light perceived by an observer 30 in any localised region is variable by constructing the fuel element 20c so that wall 34 locally varies in thickness. The local variation in thickness of the wall 34 may be achieved by the particular local shape of the internal surface 35 of the wall 34 and/or by the local shape of the external surface 36 of the wall 34. For example, the external surface 36 may be formed with shallow crevices running longitudinally along the fuel element 20c resembling corresponding crevices in the bark of a burning log. Also, the fuel element may comprise more than one cavity 32 together with regions where there is no cavity. Thus, considering the fuel element as a whole, the perceived intensity of transmitted light may vary considerably from place to place on the fuel element. The intensity or brightness of the perceived light passing through the wall 34 of the fuel element 20c may also be determined by the manner in which the outer surface of the fuel element 20c is coloured. Thus areas of thicker or darker colour will result in a lower perceived brightness and conversely areas of lighter or thinner colour will result in greater perceived brightness. For example, the fuel element 20c may comprise on surface 36 lands defined between two of the shallow crevices described above. The lands may be coloured in substantially opaque brown, black and grey colours so that no light, or little light, is transmitted therethrough whereas the adjacent shallow crevices, which define relatively thin areas of the wall 34, may transmit a substantial amount of light. Thus, the fuel element has the appearance of burning in the glowing crevices either side of darker (non-burning) lands, which provides a highly realistic effect. The perceived intensity of the light transmitted through the fuel element 20c may preferably also be caused to vary in a pseudo-random manner by interposing a flicker element 60 between the light source 40 and the aperture 12 and cavity 32.

An additional fuel element 20b is provided in the variation illustrated in FIG. 3. The fuel element 20b is essentially the same as that of fuel elements 20, 20a and 20c. However, fuel element 20b is constructed to resemble a fuel element having a burning surface 28 facing away from the observer 30. For example the fuel element may be constructed to represent a half log with the “cut” surface of the log facing away from the observer 30. Disposed behind the fuel elements 20a, 20b is a screen 80. The screen has a surface 82 which is at least partially reflective. For example the screen may have an at least partly mirrored finish. In this way, a reflection of the fuel elements 20b, 20c and of the ember bed 10 may be seen by the observer 30 in the screen 80. The reflections are schematically illustrated as virtual fuel elements 20c′ and 20b′. Clearly, the surface 28 also has a reflection 28′ in the screen 80 and the ember bed 10 has a reflection 10′. The reflection of the fuel elements 20b, 20c and of the ember bed 10 provides the illusion of a fuel bed having substantially twice the front-to-back depth of the actual fuel bed.

The surface 28 facing the screen 80 may be provided with a glossy and reflective surface 70′, similar to the surface 70 of FIG. 1. The surface 28 may also be provided with one or more localised reflective areas 25. The image in the reflective screen 80 of the glossy and reflective surface 70′ and/or of the localised reflective areas 25 is visible to the observer 30. In a preferred arrangement, the screen 80 is also partially transmissive of light so that the surface 28 can be illuminated by light from the light source 40 passing through the screen 80 from the rear to the front. In this case, the light source 40 can be suitably placed so that light can pass directly from the light source 40 through the screen or, more preferably, light from the light source 40 may be indirectly incident on the screen 80. In the illustrated example, baffle 42 prevents light from the light source 40 from falling directly on the screen 80. In this example, light from light source 40 falls on flicker element 60 and is reflected by the flicker element 60 (via a flame effect element 90 described below) through the screen 80. This has the advantage that light transmitted through the screen 80 and incident on the surface 28 has a pseudo-randomly varying intensity. This, in combination with the surface 70′ and the localised reflective area(s) 25 enhances the burning illusion of the image 28′ of surface 28 as perceived by the observer 30.

Additional fuel elements 20b and/or a reflective screen 80 may also be provided in modifications of the embodiments shown in FIGS. 1 and 2.

FIG. 4 schematically illustrates a fuel effect fire incorporating a fuel bed with an ember bed and fuel elements. The fire includes a light source 40, a light baffle 42a, flicker elements 60 and 60′, and reflector 50 for directing light from the light source onto the underside of the fuel bed 10. The fire further includes a partially transmitting and partially reflecting screen 80 on which light reflected by flicker element 60′ is incident. Interposed between the flicker element 60′ and the screen 80 is a flame effect element 90. The flame effect element 90, which is shown schematically simply as a line, serves to provide an illusion of flames in the screen 80. The flames appear to arise from between the fuel bed and its image in the screen 80. Many flame effect elements and constructions are known in the art and the skilled person can select appropriate components to achieve the flame effect. In some constructions, for example, the flame effect element may be a sheet of material with flame shaped cut-outs. In other constructions, the flame effect element 90a may be a material having generally flame shaped reflective areas mounted proximate the rear wall 92 of the fire so as to reflect light from the flicker element 60, as illustrated in FIGS. 1 to 3.

FIG. 4 also illustrates a fuel element 20d which illustrates that a fuel element according to the invention may incorporate one or more of the features of fuel elements 20, 20, 20b and 20c. Fuel element 20d includes a cleft 24, a channel 26 and glossy reflective surface 70″, analogous to areas 70 and 70′. Although not specifically shown in the illustration, the fuel element 20d may also, of course, include at least one cavity 32.

FIG. 5 illustrates a typical arrangement of a fuel bed of a fire according to the invention including an ember bed 10 and simulated fuel elements shown generically as 20e. Each of the fuel elements 20e may in principle include any combination of the features of fuel elements 20, 20a, 20b, 20c and 20d. A partially transmissive partially reflective screen 80 is provided behind the fuel elements 20e to provide a reflection of the fuel elements 20e, as shown, for example, in ghost lines at 20e′. The screen 80 also provides an illusion of flames shown schematically at 84. The flames 84 as illustrated are only indicative of the actual flame illusion which has constantly moving flames. The illusion of flames 84 is provided by light from light source 40 falling on the screen 80 after having been modified by flicker element 60 and flame effect element 90a.

In FIG. 6, which is a section along line 6-6 of FIG. 5, the lower fuel element 20e includes a cleft 24 which is open at its lower end to a red or orange coloured filter 44 through which light reflected by flicker element 60 passes, giving the effect of a warm burning colour to the fuel element 20e. An upper fuel element 20e rests above the cleft 24 and is constructed to resemble a piece of bark. The lower (front) surface of the upper fuel element 20e is provided with a glossy reflective surface 70e which is the same as surfaces 70, 70′, 70″ described above. The surface 70e is reflective of light passing through channel 24, giving the illusion of burning and glowing to the simulated bark 20e. The upper (rear) surface of the upper fuel element 20e may also be provided with a dark glossy reflective surface 70e which is reflective of light transmitted through screen 80. Light reflected by surface 70e is in turn reflected by screen 80 and is thus perceivable by an observer as a burning and glowing effect of the reflection in screen 80 of upper fuel element 20e.

In FIG. 7, the lower fuel element 20e is functionally largely the same as the lower fuel element of FIG. 6, although it is constructed to have a different appearance. Thus the lower fuel element 20e includes a cleft 24 which opens onto a filter 44 above an aperture 12 in the ember bed. First and second upper fuel elements 20e¹ and 20e² have portions which lie above cleft 24. Each of these portions includes a dark glossy reflective surface 70e which is reflective of light passing through channel 24 to provide the fuel elements 20e¹ and 20e² with the appearance of glowing and burning regions. A similar dark glossy surface may be provided on an inner face of channel 24.

In FIGS. 5, 6 and 7 the fuel pieces 20e may also be provided in suitable locations with localised reflective areas 25.

It can be appreciated that, although it is most certainly preferable, it is not essential for the fuel elements to be made from the above described foam material. Other materials can be considered. However, the foam material is advantageous in the enables the fuel elements to be relatively easily manufactured in a variety of shapes which can be very realistically coloured or decorated to represent real fuel elements. The foam fuel elements are also light in weight and sufficiently durable in use. The ability of the foam material to be partially transmissive of light is another important factor in achieving a realistic burning effect, which is not attainable with conventional simulated fuel elements. With particular regard to fuel elements 20c comprising internal cavity 32, alternative materials may be considered but any such materials must have the required property of being diffusive and partially transmissive of light in order to achieve the advantageous effects of the present invention. For this reason, the above described foam materials are particularly preferred.

FIGS. 8 and 9 illustrate a further feature of the invention in the form of a fixing means for attaching a fuel element 20 to an ember bed 10. The fitting 100 which may conveniently be a moulded plastic material comprises a head portion 102, a shank 104 and an engagement portion 106. Advantageously, the shank 104 is provided with a lip 108. The engagement portion 106 may be shaped so that it can be grasped by a user's finger and used to turn the fixing about its longitudinal axis A-A. Alternatively, the engagement portion 106 may include a relatively flat land on its end face 106a which land includes a slot or the like for receiving the blade of a screwdriver or coin, by means of which the fixing 100 may be rotated. The head portion 103 may be shaped generally like a flat arrowhead as illustrated or may have another suitable shape, such as a “T” shape.

The fuel elements of the invention are not required to possess significant inherent strength since their purpose is primarily decorative. Neither is it necessary for the fuel elements 20 to be able to resist significant displacement forces during use. Thus the fixing 100 is required only to retain the fuel element 20 in its position of use for the while the fuel bed is, in turn, in its position of use and, possibly, during transit of the fuel bed from, for example, manufacturer to the retailer/wholesaler and to the end user. When in its position if use, the fuel element 20 will normally be protected from accidental knocks and shocks. In view of the above the light and somewhat brittle or friable nature of the foam material of which the fuel elements 20 are comprised can be turned to advantage. Thus, for use of the fixing 100, a slot 12a is provided in the ember bed 10 and the fixing is inserted into the slot. The slot 12a may conveniently have a length similar to the width of the head portion 102 and a width similar to the width of the shank 104. In use, the head portion 102 is passed through the slot 12a. The fuel element 20 is, at this stage, disposed on the ember bed 10 and the head portion 102 penetrates the foam material of the fuel element 20. If present, the lip 108 may have a latching action with the inner surface of the ember bed 10 to resist withdrawal of the fixing 100. When the fixing has been pushed in for the required distance—so that the engagement portion 106 is brought into contact with the ember bed 10—the engagement portion 106 is used to turn the fixing about its axis A-A by, say, 90° or 180° and in any case less than 360° (the specific amount by which the fixing 100 is turned is not crucial). The head portion 102 thus becomes engaged with the foam material of the fuel element 20 so that the fuel element 20 is retained on the ember bed 10. For ease of location of the fuel element 20 in its correct position, the fuel element may be provided with pre-formed bores for receiving the head portion. Of course, the diameter of any such bores must be less than the width of the head portion.

1. A simulated fuel element for a fuel effect fire comprising:
a body of rigid substantially non-transparent material having at least a first part of its external surface, which is visible when the simulated fuel element is in its intended position of use, shaped and colored to resemble a real fuel element;
wherein the fuel element comprises at least one region having a dark-colored and light-reflecting surface.

2. A simulated fuel element as claimed in claim 1 wherein the body of material comprises a polyurethane foam.

3. (canceled)

4. A simulated fuel element as claimed in claim 1 wherein the dark-colored surface is black and/or mid to dark brown.

5. A simulated fuel element as claimed in claim 1 wherein the light reflecting surface comprises a coating material selected from a lacquer, varnish or gloss paint applied to the surface of the simulated fuel element.

6. A simulated fuel element as claimed in claim 1 wherein said dark-colored surface is a non-planar surface.

7. A simulated fuel element as claimed in claim 1 wherein said dark-colored surface is a rough or irregular surface.

8. A simulated fuel element as claimed in claim 1 further comprising a crevice, cleft or fissure extending towards the interior of the fuel element from an external surface thereof.

9. A simulated fuel element as claimed in claim 8 wherein a said region having a dark-colored surface is provided on an internal surface of said crevice, cleft or fissure.

10. A simulated fuel element as claimed in claim 9 further comprising at least one cut-out, passage or channel extending from a surface thereof not visible in use into said crevice, cleft or fissure.

11. A simulated fuel element as claimed in claim 10 wherein said at least one cut-out or channel terminates at a point in said crevice, cleft or fissure which is not visible when the fuel element is in its intended position of use.

12. A simulated fuel element as claimed in claim 1, further comprising at least one internal cavity having an open face on a side of said element not visible when the fuel element is in its intended position of use and defining a wall region between said cavity and an area of the surface of the element which is visible is use, said wall region having a thickness sufficiently small that it is partially translucent to light incident on the wall region.

13. A simulated fuel element as claimed in claim 1 further comprising pieces of reflective material applied to an external surface thereof.

14. A simulated fuel element as claimed in claim 13, said pieces being positioned to reflect light onto said at least one region having a dark-colored and light-reflecting surface.

15. A simulated fuel effect fire including a fuel bed and a light source located below the fuel bed, the fuel bed comprising:
i. an ember bed; and
ii. at least one fuel element mounted on the ember bed and comprising a body of rigid substantially non-transparent material having at least a first part of its external surface, which part is visible when the simulated fuel element is so mounted, shaped and colored to resemble a real fuel element,
wherein the fuel element comprises at least one region having a dark-colored and light-reflecting surface on which light from the light source is directly or indirectly incident.

16. A simulated fuel effect fire as claimed in claim 15 wherein the body of material comprises a polyurethane foam.

17. (canceled)

18. A simulated fuel effect fire as claimed in claim 15 wherein the dark-colored surface is black and/or mid to dark brown.

19. A simulated fuel effect fire as claimed in claim 15 wherein the light reflecting surface comprises a coating material selected from a lacquer, varnish or gloss paint applied to the surface of the simulated fuel element.

20. A simulated fuel effect fire as claimed in claim 15 wherein said dark-colored surface is a non-planar surface

21. A simulated fuel effect fire as claimed in claim 15 wherein said dark-colored surface is a rough or irregular surface.

22. A simulated fuel effect fire as claimed in claim 15 wherein said fuel element further comprises a crevice, cleft or fissure extending towards the interior of the fuel element from an external surface thereof.

23. A simulated fuel effect fire as claimed in claim 22 wherein said fuel element further comprises at least one cut-out, passage or channel extending from a surface thereof not visible when the fuel element is mounted on the ember bed into said crevice, cleft or fissure through which cut-out, passage or channel light from the light source may pass into said crevice, cleft or fissure.

24. A simulated fuel effect fire as claimed in claim 23 wherein light passing through said cut-out, passage or channel is incident on a said dark-colored surface of the fuel element.

25. A simulated fuel effect fire as claimed in claim 23 wherein light passing through said cut-out, passage or channel is incident on a said dark-colored surface of a further fuel element mounted above said crevice, cleft or fissure.

26. A simulated fuel effect fire as claimed in claim 23 wherein said at least one cut-out, passage or channel terminates at a location in said crevice, cleft or fissure which is not visible when the fuel element is in its intended position of use.

27. A simulated fuel effect fire as claimed in claim 15 wherein the ember bed comprises at least one hole or substantially transparent area for the passage of light from the light source.

28. A simulated fuel effect fire as claimed in claim 27 wherein a colored filter is provided in the path of light through said hole or substantially transparent area.

29. A simulated fuel effect fire as claimed in claim 15 wherein said fuel element further comprises at least one internal cavity having an open face on a side of said element not visible when the fuel element is mounted on the ember bed and defining a wall region between said cavity and an area of the surface of the element which is visible is use, said wall region having a thickness sufficiently small that it is partially translucent to light from the light source directly or indirectly incident on the wall region.

30. A simulated fuel effect fire as claimed in claim 29 wherein said fuel element further comprises at least one internal cavity having an open face disposed over a hole or substantially transparent area of the ember bed and defining a wall region between said cavity and an area of the surface of the element which is visible is use, said wall region having a thickness sufficiently small that it is partially translucent to light from the light source passing through a hole or transparent region of the ember bed.

31. A simulated fuel effect fire as claimed in claim 15 wherein the fuel element further comprises pieces of reflective material applied to an external surface thereof.

32. A simulated fuel effect fire as claimed in claim 31 wherein said pieces of reflective material are so positioned that light from the light source is incident thereon.

33. A simulated fuel effect fire as claimed in claim 15 wherein the fuel element further comprises pieces of reflective material applied to an external surface thereof.

34. A simulated fuel effect fire as claimed in claim 33 wherein said pieces of reflective material are so positioned that light from the light source is incident thereon and is reflected onto said at least one region having a dark-colored and light reflecting surface.

35. A simulated fuel effect fire as claimed in claim 15 further comprising a reflective screen mounted behind the fuel bed whereby a reflection of the fuel bed may be observed in the reflective screen.

36. A simulated fuel effect fire as claimed in claim 35 wherein at least one dark-colored and light-reflecting surface of a fuel element is arranged to face the reflective screen whereby a reflection of the said surface may be observed in the reflective screen.

37. (canceled)

38. A simulated fuel element as claimed in claim 1, further comprising a foam material.

39. A simulated fuel element as claimed in claim 15, further comprising a foam material.
